(19) United States
(12) Patent Application Publication
(10) Pub. No.: US 2009/0304213 A1
(43) Pub. Date: Dec. 10, 2009

(54) Stereophonic Sound Imaging

(75) Inventors: Bryan Austin Cook, Mountain View, CA (US); Michael John Smithers, New South Wales (AU)

Correspondence Address: Dolby Laboratories Inc., 999 Brannan Street, San Francisco, CA, 94103, US

(73) Assignee: Dolby Laboratories Licensing Corporation, San Francisco, CA (US)

(21) Appl. No.: 12/225,134

(22) PCT Filed: Mar. 14, 2007
(86) PCT No.: PCT/US2007/006520

§ 371 Date: Jul. 27, 2009

Related U.S. Application Data
(60) Provisional application No. 60/783,179, filed on Mar. 15, 2006.
(60) Provisional application No. 60/844,872, filed on Sep. 14, 2006.

(51) Int. Cl. H04R 5/02

(52) U.S. Cl. 381/300

(57) ABSTRACT

A method for reducing phase differences varying with frequency occurring at certain listening positions with respect to loudspeakers reproducing respective ones of multiple sound channels in a listening space, the phase differences occurring in a sequence of frequency bands in which the phase differences alternate between being predominantly in-phase and predominantly out-of-phase, comprises adjusting the phase in multiple frequency bands in which the multiple sound channels are out-of-phase at such listening positions. Such adjustment of phase includes the frequency bands in which the width of comb filtering pass bands and notches resulting from phase differences at such listening positions would be greater than or commensurate with the critical band width if the phase adjustment were not applied. The listening space may be the interior of a vehicle.

### FIELD OF THE INVENTION

The present invention relates to audio signal processing. More particularly, the invention relates to improving the perceived sound image and direction of sound images presented using a stereophonic (“stereo”) playback system, particularly for two listening positions symmetric about the center line of such a stereophonic playback system. Aspects of the invention include apparatus, a method, and a computer program stored on a computer-readable medium for causing a computer to perform the method.

### BACKGROUND OF THE INVENTION

Two-channel stereophonic playback systems are almost ubiquitous in many environments including live sound, home music playback and automotive sound. A common effect is that sounds, radiated by a pair of stereo loudspeakers sound different at different listening positions relative to the loudspeakers. These variations are primarily caused by the difference in time taken for the sounds from each speaker to arrive at, and acoustically sum at, the listening position. Secondary effects include interactions of the sounds with the room but these effects are not discussed here.

Temporal differences at a listening position are equivalent to a phase difference that varies with frequency. For the following discussion, the term “inter-loudspeaker differential phase” (IDP) is defined as the difference in phase of sounds arriving at a listening position from a pair of stereo loudspeakers.

A listener located equidistantly from two loudspeakers experiences essentially no IDP because sounds presented by both loudspeakers take the same amount of time to reach the listener's ears (see FIG. 1a). A listener offset from a pair of stereo loudspeakers, that is, where a listener is closer to one of the loudspeakers, experiences an IDP whose magnitude increases linearly with frequency (see FIG. 2a).

Variations in IDP result in audible and undesirable effects including comb filtering and blurring of imaging of audio signals presented through a pair of stereo loudspeakers. A simple solution is to delay the signals presented through the closer loudspeaker. The amount of delay used is such that signals presented through both loudspeakers arrive at a listener's ears at the same time. The result is that the IDP for the listener is zero and the listener experiences no undesirable imaging artifacts.

The use of simple delay, however, is not suitable for environments such as vehicles where two listeners may be symmetrically off center which respect to a pair of stereo loudspeakers—that is, where one listener is closer to the left loudspeaker and the other listener is closer to the right loudspeaker (see FIG. 3). In this environment, correcting the IDP for one listener by using delay makes the experience worse for the other listener due to an increase in the rate of change of IDP across frequency. The resulting effect can be unnatural enough as to cause the other listener significant discomfort.

For audio signals where directionality and imaging is important, that is signals that have a significant steady-state component, an alternative to time correction is to adjust the IDP directly, that is to adjust the phase of various frequencies. For individual frequencies, phase is circular. That is a phase of any value maps onto a circular space of 360 degrees. For this analysis, phase values are limited to between −180 and 180 degrees, giving a total range of 360 degrees. To give an example of the circularity, consider a phase value of 827 degrees or 2×360+107 degrees, which is equivalent to 107 degrees. Similarly, −392 degrees or −1×360−32 degrees is equivalent to −32 degrees. For reasons discussed below, frequencies with values closer to 0 degrees than −180 or 180 degrees (i.e., between −90 and 90 degrees) are considered “in phase” or reinforcing and frequencies closer to −180 or 180 degrees than 0 degrees (i.e., between 90 and 270 degrees or between 90 and −90 degrees) are considered “out of phase” or canceling (see FIGS. 4a and 4b).

In a typical vehicle environment, the IDP for each listener is as follows. Frequencies between 0 and approximately 250 Hz are predominantly in phase—that is the IDP is between −90 and 90 degrees. Frequencies between approximately 250 Hz and 750 Hz are predominantly out of phase—that is the IDP is between 90 and 270 degrees. Frequencies between approximately 750 Hz and 1250 Hz are predominantly in phase. This alternating sequence of predominantly in phase and predominantly out-of-phase bands continues with increasing frequency up to the limit of human hearing at approximately 20 kHz. In this example, the cycle repeats every 1 kHz. The exact start and end frequencies for the bands are a function of the interior dimensions of the vehicle and the location of the listeners.

It is widely accepted that the human auditory system is sensitive to phase differences up to approximately 1500 Hz. Thus, below approximately 1500 Hz, the variation in the IDP leads to significant distortion of the apparent spatial direction or image of the audio signal. This is in addition to the magnitude distortion due to comb filtering, which is audible both below and above 1500 Hz.

It is also widely understood that the human auditory system analyzes a broad spectrum into smaller groups of frequencies or bands called critical bands. A critical band represents the smallest difference in frequency where two frequencies can still easily be heard separately, and this difference varies with frequency. At low frequencies, critical bands are very narrow and widen with increasing frequency. In discussions below, “bands” refer to bands of frequencies in which the sound reaching a listener from multiple loudspeakers are in phase and out of phase. In the discussions below, critical bands are referred to as “critical bands.”

In the vehicle environment described above, the comb filtering effect can be distinctly heard for frequencies below approximately 4 kHz because the width of the peaks and notches, approximately 500 Hz, is equivalent to or larger than the critical band width. Above approximately 6 kHz, the critical bandwidth becomes larger than the combined width of one peak and one notch, and the comb filtering effect becomes essentially inaudible.

Thus, in accordance with an aspect of the invention, it is preferred to adjust the IDP for frequencies up to the frequency at which the critical bandwidth becomes larger than the combined width of one peak and one notch of the comb filter, approximately 6 kHz. This may be achieved by performing phase adjustments on multiple frequency bands in both channels of the audio signal, thus correcting the inter-loudspeaker differential phase at each listening position. Once applied, the resulting IDP observed at the listening position ideally is within plus/minus 90 degrees for both listeners (see FIGS. 11a and 11b). Reducing the IDP in that manner significantly improves perceived imaging and reduces the magnitude distortion from very audible comb filtering with deep, wide nulls to a relatively benign ripple of plus/minus 3 dB that is substantially inaudible for most listeners and sound content.

A number of methods in the prior art only look at the IDP below approximately 1 kHz. They attempt to correct the IDP for both listeners in the lowest frequency band where sounds reaching the listener are predominantly out of phase. They do this by using filters and phase shifters to essentially add 180 degrees to the IDP in this band. The result is that below 1 kHz, the corrected IDP for both listeners is between −90 and 90 degrees. That is, frequencies below 1 kHz are predominantly in phase for each listener and the listeners experience greatly improved imaging. The main deficiency with such methods is that they ignore the IDP at higher frequencies where phase correction can be beneficial.

U.S. Pat. No. 4,817,162 teaches the use of filters and phase shifters in both channels to add 180 degrees to the relative phase of signals between the left and the right channel for frequencies in the range of 200 Hz to 600 Hz. In this teaching, this frequency range represents the first band where sounds reaching the listener are predominantly out of phase at both listening positions (see FIGS. 5a and 5b). A problem with this teaching is that the phase shifters do not provide a fast enough rate of change of phase at the band edges to provide a substantial correction of the IDP.

U.S. Pat. No. 5,033,092 teaches use of filters and phase shifters, in the frequency range of 200 Hz to 1 kHz, to advance the phase of one channel by 60 to 90 degrees and advance the phase of the other channel by −60 to −90 degrees. In this teaching, 200 Hz represents approximately the start of the first band where sounds reaching the listener are predominantly out of phase. When each channel is advanced by 90 and −90 degrees respectively in this band, the total relative phase difference in this band is 180 degrees. The intended result is similar to the method of U.S. Pat. No. 4,817,162. A significant benefit of this teaching is that because the phase of each channel is adjusted at most by 90 degrees, the magnitude distortion in each channel is limited to a maximum of 3 dB. Whereas, if the relative 180 degrees of phase shift had been created by filtering only one channel, that channel would have audible nulls in its magnitude response. That is, the magnitude response would drop to zero in the transition from in 0 to 180 degrees and vice versa.

U.S. Pat. No. 6,038,323 teaches the use of filters and phase shifters to add 180 degrees to the phase of all frequencies above 300 Hz. In this teaching, 300 Hz represents the start of the first band where sounds reaching the listener are predominantly out of phase for each listening position. To simplify the filter design, frequencies higher that the first band are kept out of phase, the justification of this teaching being that humans are not sensitive to IDP for frequencies above this first out-of-phase band (see FIGS. 6a and 6b). This teaching ignores the fact that magnitude distortion due to comb filtering can be heard for frequencies above this first band.

### SUMMARY OF THE INVENTION

A goal of the present invention is to improve the perceived imaging of audio signals presented over a stereophonic playback system for listeners that are positioned symmetrically off center from the playback system. This is achieved by performing phase adjustments to multiple frequency bands in both channels of the audio signal, thus correcting the inter-loudspeaker differential phase at each listening position.

### BRIEF DESCRIPTION OF THE DRAWINGS

FIG. 1a shows schematically the spatial relationship of a listening position and two loudspeakers in which the listening position is equidistant from the loudspeakers.

FIG. 1b shows an idealized interaural phase difference (IDP) response for all frequencies at the equidistant listening positions of FIG. 1a. This example shows how the IDP at such listening positions does not vary with frequency.

FIG. 2a shows schematically the spatial relationship of a listening position offset in relation to two loudspeakers.

FIG. 2b shows an idealized interaural phase difference (IDP) response for all frequencies at the listening position of FIG. 2a. This example shows how the IDP at the listening position varies with frequency.

FIG. 3 shows schematically the spatial relationship of two listening positions, each offset symmetrically in relation to two loudspeakers.

FIGS. 4a and 4b show how the IDP varies with frequency for each of the two listening positions of FIG. 3.

FIGS. 5a and 5b show an idealized IDP response at two listening positions in a system practicing the teachings of U.S. Pat. No. 4,817,162.

FIGS. 6a and 6b show an idealized IDP response at two listening positions in a system practicing the teachings of U.S. Pat. No. 6,038,323.

FIG. 7a shows a functional schematic block diagram of a possible FIR based implementation of aspects of the invention, as applied to one of two channels, in this case, the left channel.

FIG. 7b shows a functional schematic block diagram of a possible FIR based implementation of aspects of the invention, as applied to one of two channels, in this case, the right channel.

FIG. 8a is an idealized magnitude response of the signal output 703 of the filters or filter functions 702 of FIG. 7a.

FIG. 8b is an idealized magnitude response of the signal output 709 of the subtractor or subtractor function 708 of FIG. 7a.

FIG. 9a is an idealized phase response of the output signal 715 of FIG. 7a.

FIG. 9b is an idealized phase response of the output signal 735 of FIG. 7b.

FIG. 9c is an idealized phase response representing the relative phase difference between the two output signals 715 (FIG. 7a) and 735 (FIG. 7b).

FIG. 10a shows the tolerances of an idealized IDP compensation filter, indicating its desired phase requirements.

FIG. 10b is the desired phase response used as an input to the Eigenfilter design algorithm.

FIG. 10c is the weighting function used for the Eigenfilter design algorithm.

FIG. 11a is an idealized IDP phase response for the left listening position of FIG. 3 when employing the FIR filter of FIG. 7a.

FIG. 11b is an idealized IDP phase response for the right listening position of FIG. 3 when employing the FIR filter of FIG. 7b.

FIG. 12 shows the realized magnitude response and an idealized phase response of an FIR filter before optimization.

FIG. 13 shows the realized magnitude response and an idealized phase response of an optimized FIR filter.

FIG. 14 shows the realized magnitude and phase response for an IIR filter designed using the group delay method.

FIGS. 15, 16 and 17 show the realized phase response for the Eigenfilter design algorithm with different values for h.

FIG. 18 is a schematic diagram showing an example of an all-pass filter lattice structure implementation.

FIG. 19 shows schematically the listening positions and loudspeaker layout for the front seats of an vehicle when left, center and right loudspeakers are present.

FIG. 20 shows schematically a functional block diagram in which aspects of the present invention are applied to the configuration of FIG. 19.

FIG. 21a shows schematically a four-channel loudspeaker configuration with two listening positions in which aspects of the present invention may be employed.

FIG. 21b shows schematically a four-channel loudspeaker configuration with four listening positions in which aspects of the present invention may be employed.

FIG. 21c shows schematically a six-channel loudspeaker configuration with four listening positions in which aspects of the present invention may be employed.

FIGS. 22a and 22b are functional block diagrams of a generalized filterbank implementation of idealized filters whose tolerances are shown in FIG. 10a.

FIG. 23 shows the realized poles and zeros for an IIR filter designed using the group delay method.

FIGS. 24 and 25 show the realized poles and zeros for an IIR filter designed using the Eigenfilter design algorithm before and after filter order reduction.

FIG. 26 shows the original desired phase response used for the Eigenfilter design algorithm.

FIGS. 27 and 28 show the realized phase response for an IIR filter designed using the Eigenfilter design algorithm before and after filter order reduction.

FIG. 29 shows the pre-warped desired phase response after five iterations of correction.

FIG. 30 shows the realized phase response of an IIR filter designed using the Eigenfilter design algorithm after order reduction and five iterations of correction.

### BEST MODE FOR CARRYING OUT THE INVENTION

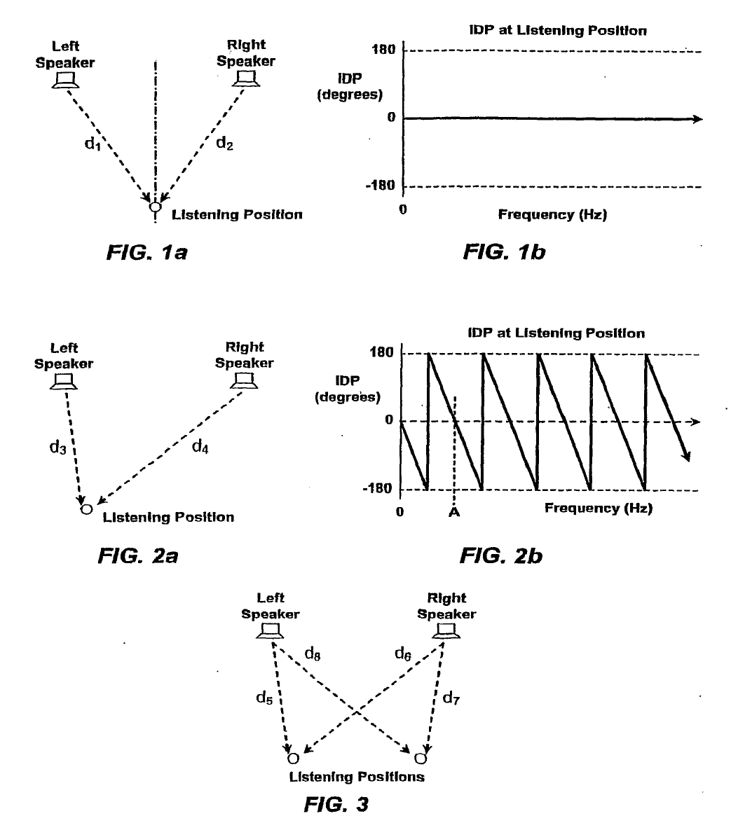

FIG. 1a shows the spatial relationship of a listening position and two loudspeakers. The distance between the listening position and the left loudspeaker d₁ is equivalent to the distance between the listening position and the right loudspeaker d₂. A line denoting other equidistant listening positions is also shown. FIG. 1b shows the interaural phase difference (IDP) for all frequencies at the equidistant listening positions. In such equidistant positions, the perceived direction and imaging of content presented through the loudspeakers tends to be natural and as the content creator intended.

FIG. 2a shows the spatial relationship of a listening position offset in relation to two loudspeakers. In this example, the distance between the listening position and the left loudspeaker d₃ is less than the distance between the listening position and the right loudspeaker d₄. FIG. 2b shows how the IDP at the listening position varies with frequency. Even though the IDP is monotonically decreasing, the figure (and all other IDP figures) show the equivalent values in the range of −180 to 180 degrees. At 0 Hz, signals are in phase and move out of phase with increasing frequency before returning to being in phase at frequency A. This phase cycle repeats with increasing frequency. The frequency at which the cycle repeats A is directly associated with the difference in distance between the listening position and the two loudspeakers. For example, if the distance to the left loudspeaker d₃ is 0.75 meters and the distance to the right loudspeaker d₄ is 1.075 meters, the difference in distance is 0.325 meters. The frequency point A equals the speed of sound divided by the difference in distance, or approximately 330 meters per second divided by 0.325, which gives 1015 Hz. Therefore, in this example, the IDP cycle repeats every 1015 Hz.

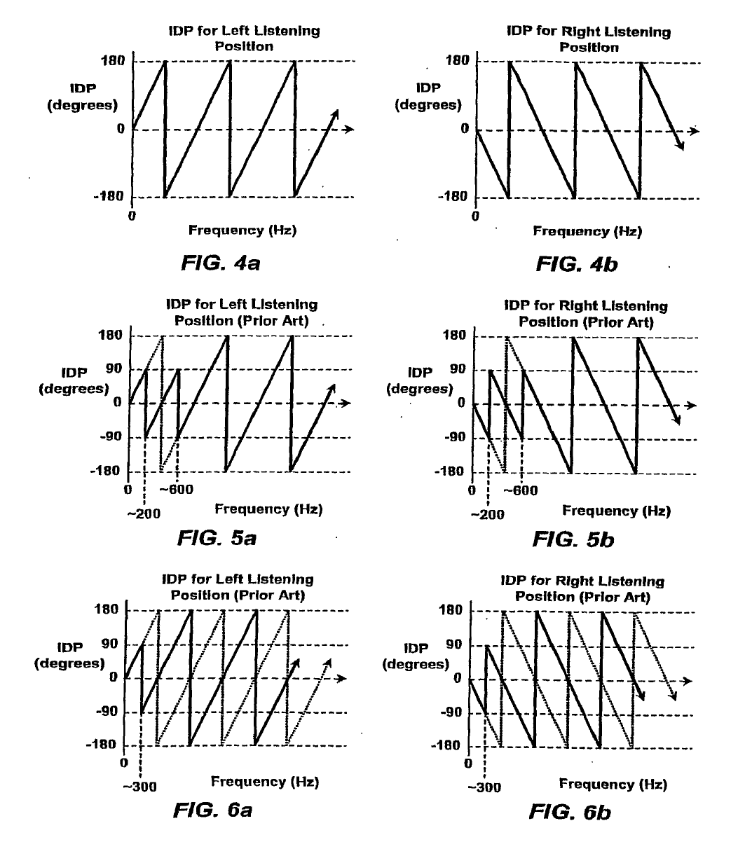

FIG. 3 shows the spatial relationship of two listening positions, each offset symmetrically in relation to two loudspeakers. FIGS. 4a and 4b show how the IDP varies with frequency for each of the two listening positions. It can be seen that for each cycle of the IDP, there are frequencies that are predominantly in phase and frequencies that are predominantly out of phase. The frequencies where the IDP is predominantly out of phase cause undesirable audible effects including blurring of imaging of audio signals presented through both loudspeakers.

FIGS. 5a and 5b show an idealized representation of the effect of the teaching described in U.S. Pat. No. 4,817,162. This teaching adds 180 degrees to the IDP for frequencies in the first band of frequencies that are predominantly out of phase. In this teaching, this band ranges from approximately 200 Hz to 600 Hz. It can be seen in FIGS. 5a and 5b that these sounds are now predominantly in phase for both listening positions. However this teaching ignores frequencies higher than 600 Hz that are predominantly out of phase. The teaching described in U.S. Pat. No. 5,033,092 is similar to U.S. Pat. No. 4,817,162 except that the frequency range treated is approximately 200 Hz to 1 kHz.

FIGS. 6a and 6b show an idealized representation of the effect of the teaching described in U.S. Pat. No. 6,038,323. This teaching adds 180 degrees to the IDP for all frequencies in and above the first band of sounds that are predominantly out of phase. In this teaching, this band starts at approximately 200 Hz. It can be seen in FIGS. 6a and 6b that the sounds in this first band are now predominantly in phase. However this teaching also ignores higher frequency bands that are predominantly out of phase reverses the position of the bands that are in phase and the bands that are out of phase.

According to an aspect of the present invention, audible comb filtering effects are minimized at certain listening positions by correcting the IDP for multiple bands of frequencies that are predominantly out of phase. While previous inventions have focused on the lowest out-of-phase frequency band, significant and audible improvement may be achieved by correcting the IDP for multiple bands up to an approximate frequency where the width of the comb filtering pass-bands and notches become similar to the critical band width. Above this frequency, no audible improvement in imaging can be achieved by correcting out-of-phase bands. In vehicles, this frequency is approximately 6 kHz but does vary slightly with actual interior dimensions of the vehicle and the relative distances to the loudspeakers.

In accordance with aspects of the present invention, audio signals are divided into in-phase and out-of-phase frequency bands and a 180 degree phase shift is added to the relative phase between the two channels for each of the out-of-phase bands. A preferred way to do this is to shift phase by 90 degrees in one channel and by −90 degrees in the other channel. An alternative way is to add 180 degrees to the bands in only one channel; however, this may cause significant and undesirable ripple in the magnitude response of the channel.

### Implementation Example

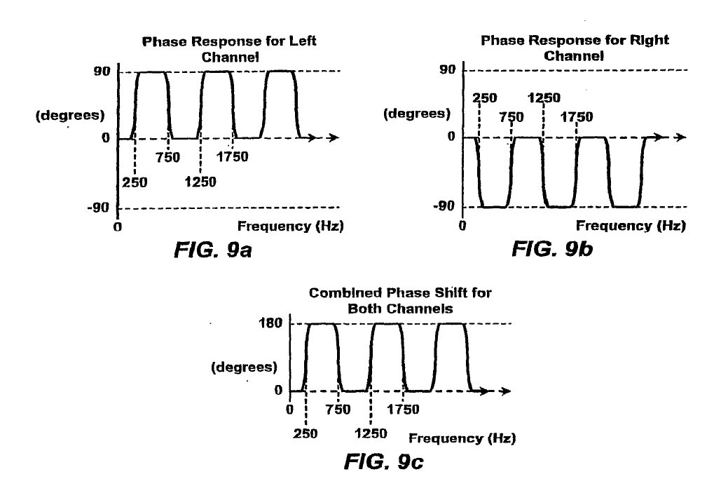

In an exemplary embodiment of aspects of the invention, a set of filters provides a substantially flat magnitude response and a phase response that creates a combined phase shift between the channels with alternating bands of 0 degrees and 180 degrees. To avoid undesirable ripple in the magnitude response, the left channel may be given a 90 degree phase shift, and the right channel a −90 degree phase shift. (see FIGS. 9a, 9b and 9c). If this was implemented with a 180 degree phase transition in one channel, then, at the phase transitions, the magnitude would dip toward −∞ dB. However, by using only 90 degree transitions, the maximum dip in frequency is about −3 dB. Above approximately 6 kHz the phase response is no longer as important and may be set to zero for both channels.

For some filter designs, especially digital filter designs, it may be more efficient not to terminate phase shifting of bands at a defined frequency but to continue phase shifting bands up to the Nyquist frequency. For other designs, it may be more efficient to shift only the phase of the minimum number of bands necessary to effect the desired result. For some implementations, the number of phase-shifted bands may have little or no impact on efficiency, and choices with regard to the number of phase-shifted bands may be determined by the overall filter order and resulting temporal smearing.

Based on the geometry described in FIGS. 1a, 2a and 3, the desired filter response is a function of the frequency f_{d} corresponding to a wavelength equal to the path difference between the left and right loudspeakers at the off-center listening position. This is shown in equation 1:

$${f}_{d} = \frac{c}{\vert {d}_{L} - {d}_{R} \vert} ,$$

where d_{L} is the distance from the listener to the left speaker, and d_{R} is the distance from the listener to the right speaker and c is the speed of sound (all distances in meters).

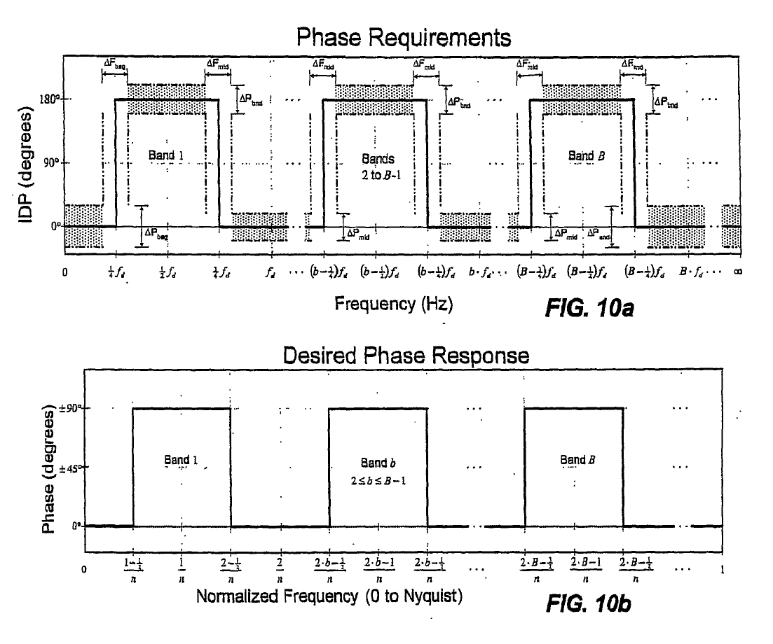

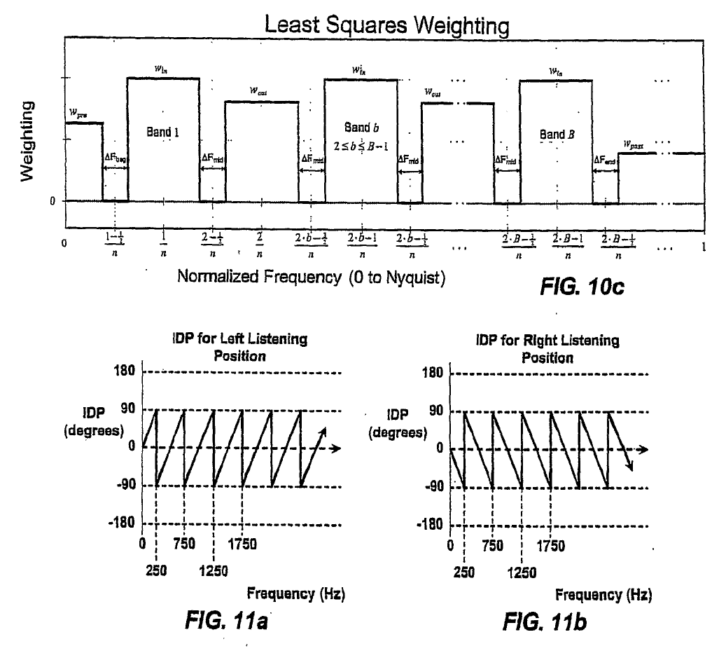

The phase performance of the IDP compensation filter may be characterized by the tolerances pictured in FIG. 10a where f_{d} is the frequency corresponding to a wavelength equal to the path difference; B is the number of bands; ΔF_{beg}, ΔF_{mid}, and ΔF_{end} are transition widths before the first band, between all bands and after the last band, respectively; ΔP_{bnd} is the phase error inside the bands; and ΔP_{beg}, ΔP_{mid}, and ΔP_{end}, are the phase errors before the first band, in between all bands, and after the last band, respectively.

Although these tolerances may be specified as substantially equal across all bands, alternatively, they may be specified differently for each band. For example it may be beneficial to have very fast transitions for the first band, where the human ear is most sensitive to phase, and have wider transitions with rising frequency to reduce the filter order and improve efficiency.

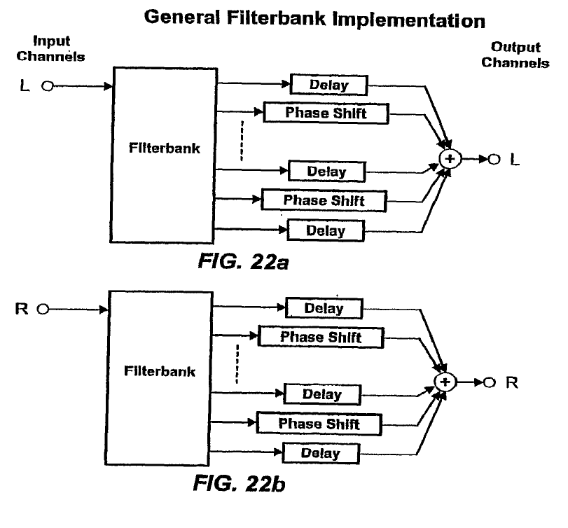

In general terms, the filters may be implemented using a filterbank that divides the left and right audio signals into subbands and in which alternating subbands are phase adjusted such that the relative phase in these subbands, between the two channels, is 180 degrees. FIGS. 22a and 22b show an example of a general filterbank implementation. Subbands that are not phase shifted may require a delay process such that their delay matches any delay imparted by the phase shifting processes. The recombination of the subbands may be accomplished by summing the subbands (see FIGS. 22a and 22b) or by an inverse filterbank.

Alternatively, the filters may be designed directly to impart the desired phase response.

An example of a filterbank-based design follows below in the discussion of finite impulse response (FIR) filters; however, a filterbank approach may use infinite impulse response (IIR) filters. Following the FIR filter discussion, a number of direct design methods are discussed that may result in very efficient IIR filters.

### Finite Impulse Response Filters

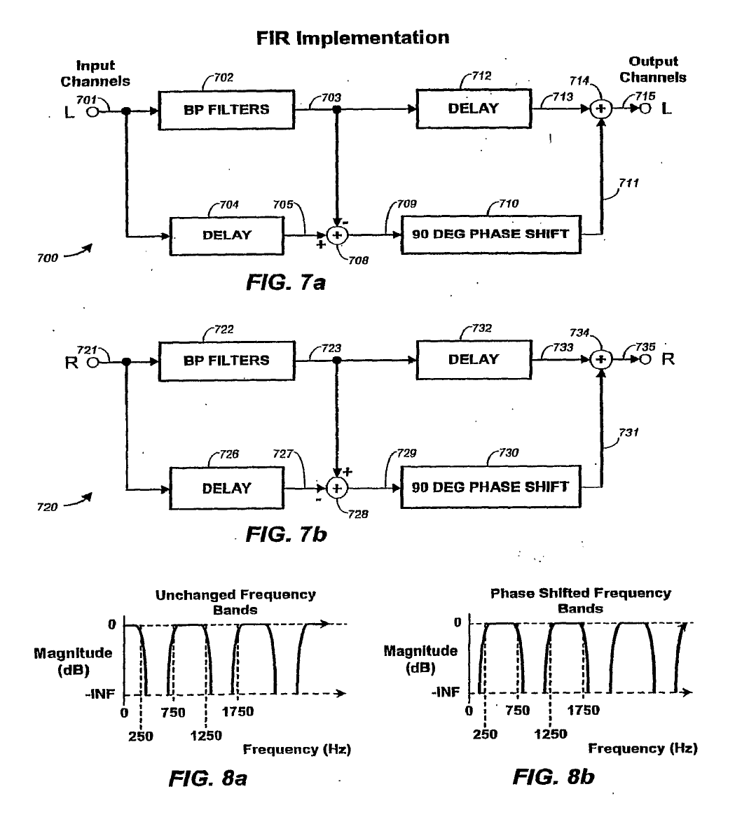

IDP phase compensation for an arrangement such as in the example of FIG. 3 may be implemented using finite impulse response (FIR) filters and linear-phase digital filters or filter functions. Such filters or filter functions may be designed to achieve very predictable and controlled phase and magnitude responses. FIGS. 7a and 7b show block diagrams of possible FIR based implementations of aspects of the invention, as applied, respectively, to one of the two channels.

In the FIG. 7a example, which, in this example processes the left channel, two complementary comb-filtered signals (at 703 and 709) are created that if summed together, would have an essentially flat magnitude response. FIG. 8a shows the comb-filter response of the bandpass filter or filter functions (“BP Filter”) 702. Such a response may be obtained with one or a plurality of filters or filter functions. FIG. 8b shows the effective comb-filter response that results from the arrangement of the BP Filter 702, the time delay or delaying function (“Delay”) 704 and the subtractive combiner 708. BP Filter 702 and Delay 704 should have substantially the same delay characteristics in order for the comb-filter responses to be substantially complementary (see FIGS. 8a and 8b). One of the comb filtered signals is subjected to a 90 degree phase shift to impart the desired phase adjustment in the desired frequency bands. Although either of the two comb-filtered signals may be shifted by 90 degrees, in this example the signal at 709 is phase shifted. The choice to shift one or the other of the signals affects the choice in the related processing shown in the example of FIG. 7b so that the total shift from channel to channel is as desired. The use of linear phase FIR filters allows both comb filtered signals (703 and 709) to be economically created using a filter or filters that select for only one set of frequency bands as in the example of FIG. 8a. Preferably the delay through BP Filter 702 is constant with frequency. This allows the complementary signal to be created by delaying the original signal by the same amount of time as the group delay of the FIR BP Filter 702 and subtracting the filtered signal from the delayed original signal (in the subtractive combiner 708, as shown in FIG. 7a). Any frequency invariant delay imparted by the 90 degree phase shift process should be applied to the non-phase-adjusted signal before they are summed together, to again ensure a flat response.

The filtered signal 709 is passed though a broadband 90 degree phase shifter or phase shift process (“90 Deg Phase Shift”) 710 to create signal 711. Signal 703 is delayed by a delay or delay function 712 having substantially the same delay characteristics as the 90 degree phase shift 710 to produce signal 713. The 90-degree-phase-shifted signal 711 and the delayed signal 713 in an additive summer or summing function 714 to create the output signal 715. The 90 degree phase shift may be implemented using any one of a number of known methods, such as the Hilbert transform. The output signal 715 has substantially unity gain, with only very narrow −3 dB dips at frequencies corresponding to the transition points between the unmodified and phase shifted bands, but has a frequency varying phase response, shown in FIG. 9a.

FIG. 7b shows a block diagram of aspects of the present invention as applied to the other of the two channels, in this case the right channel. This block diagram is very similar to that for the left channel except that the delayed signal (signal 727 in this case) is subtracted from the filtered signal (signal 723 in this case) instead of vice-versa. The final output signal 735 has substantially unity gain but has a minus 90 degree phase shift for the phase shifted frequency bands as shown in FIG. 9b (compare to positive 90 degrees in the left channel as shown in FIG. 9a).

The relative phase difference between the two output signals 715 and 735 is shown in FIG. 9c. The phase difference shows a 180 degree combined phase shift for each of the frequency bands that are predominantly out-of-phase for each listening position. Thus, out-of-phase frequency bands become predominantly in phase at the listening positions. The resulting corrected IDP for each listening position (see FIG. 3) is shown in FIGS. 11a and 11b.

### FIR Magnitude and Phase Response

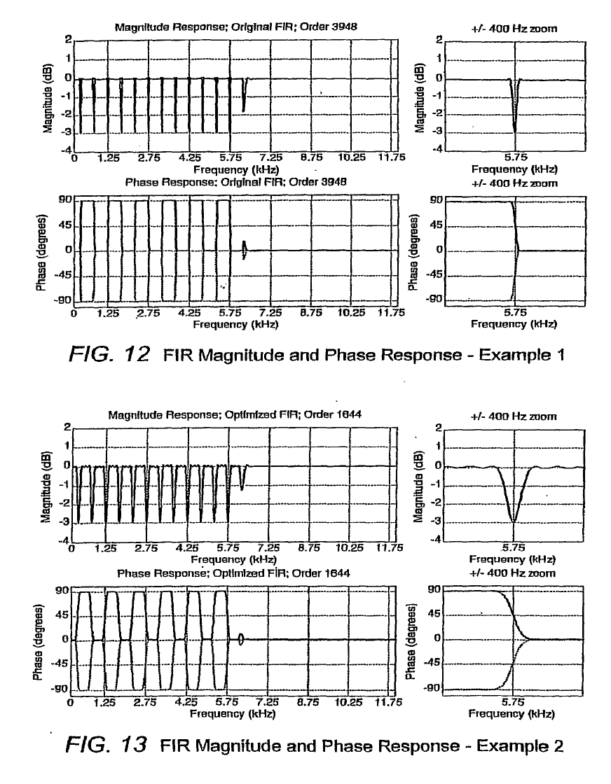

Due to the nature of FIR filters, it is impossible to create an FIR filter that is all-pass (except for a pure delay). Thus, there is, unavoidably, some deviation in the filter magnitude response. For the FIR implementation described above, FIGS. 12 and 13 provide magnitude and phase response examples for two different filter orders.

During the transition region between bands, there is a −3 dB dip in the magnitude response. With increasing filter order, the width of dip becomes smaller, and the phase transition from +/−90 to 0 becomes faster. However, a larger filter order dictates a larger impulse response.

Although FIR filters are easy to design, they have certain characteristics that are undesirable for implementing aspects of the present invention. First, they require a relatively long impulse response to achieve a required magnitude and phase response—a long impulse response results in high computational complexity. Second, long impulse responses result in audible and undesirable time smearing for impulsive or percussive audio signals.

### FIR Implementation Considerations

For efficiency, filters or filter processes 702 and 722 in FIGS. 7a and 7b, respectively, may be configured as an equally spaced comb filterbank followed by a low-pass filter. The comb filter may be efficiently implemented as a sparse FIR filter. A low-pass filter may be employed to stop the phase adjustment of bands above the desired cutoff frequency.

Devices or processes 710 and 730 are 90 degree phase shifting filters or filter processes. For a filter that works well for most audio frequencies at sampling rates of 44.1 kHz and 48 kHz, between 400 and 800 filter taps are needed. Because implementation using direct convolution is expensive, Fast Fourier Transforms (FFT's) may be used to employ fast convolution.

Also, for sampling rates of 44.1 kHz and 48 kHz, the low-pass filter of filter process should have between 200 and 400 taps. It also may benefit from fast convolution and may be combined with the 90 degree phase shifting filter or filter process.

### Infinite Impulse Response Filters

A preferred implementation uses infinite impulse response (IIR) all-pass filters to achieve the desired phase response. IIR filters have the advantage that for a desired phase and magnitude response, they typically have a shorter impulse response than a similar FIR filter. The shorter impulse response results in both reduced computational complexity and reduced time smearing. However, IIR filters are difficult to design.

### Group Delay Method

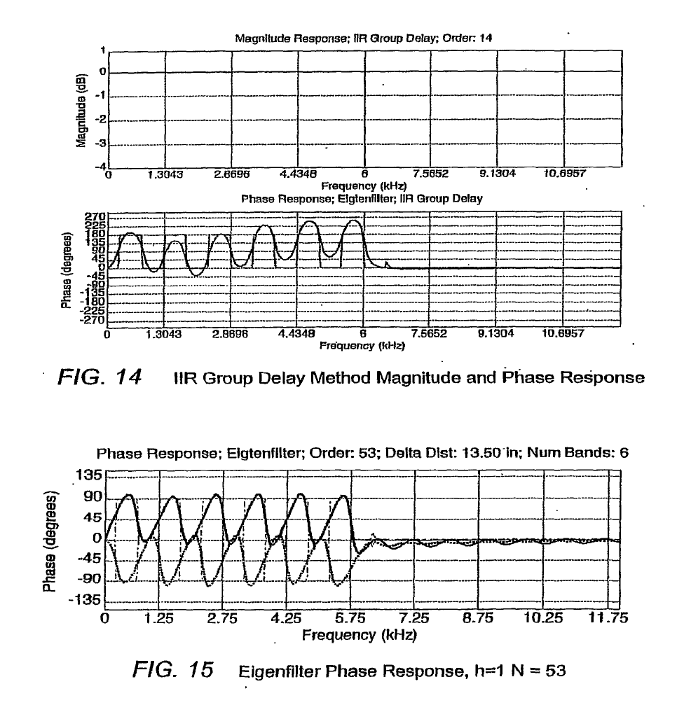

Most classical 11R filter design techniques are focused on matching a specified magnitude response. However there are several techniques for designing all-pass IIR filters. One method for all-pass filter design is based on finding the least p^{th} order fit to the desired group delay. This method may be implemented, for example, by using a computer tool such as MATLAB (MATLAB is a trademark of The MathWorks, Inc.). The MATLAB function iirgrpdelay.m may be used, which is part of the Filter Design Toolbox. In implementing aspects of the present invention, the ideal phase response is alternating bands with sharp transitions. Because group delay is the first derivative of phase, the ideal group delay is 0 within the bands and ±∞ at the transitions. Because such discontinuities are impossible to fit with a least p^{th} order algorithm, it is necessary to find an approximation to the ideal phase response that has a derivative without discontinuities. By choosing the desired phase response to be a sinusoid that is optimally aligned with the desired bands, it is possible to design IIR filters that approximate the desired response. FIG. 14 shows the magnitude and phase response for a filter designed using the group delay method.

However, the group delay algorithm becomes numerically unstable at larger orders, and often do not converge. Also, because the algorithm is fitting to the group delay, any errors in the group delay causes larger errors in the phase response due to integration. Thus, there is a lot of trial and error or searching across parameters in order to find filters with the desired performance. In addition, because the method can only design small orders, the method may not work for applications requiring the phase adjustment of large numbers of bands. That is, where the delta distance, the difference in the distance to the two loudspeakers, is large.

### Eigenfilter Method

Another technique for designing IIR all-pass filters is the Eigenfilter method. See, for example the following technical papers: T. Q. Nguyen et al, “Eigenfilter Approach for the Design of Allpass Filters Approximating a Given Phase Response”, IEEE Trans on Signal Processing, vol. 42(9), 09/1994, and Tkacenko et al, “On The Eigenfilter Design Method and Applications: A Tutorial”, IEEE Transactions On Circuits And Systems—II: Analog And Digital Signal Processing, Vol. 50, No. 9, September 1994, http://www.systems.caltech.edu/EE/Groups/dsp/students/andre/papers/journal/eigen_tutorial.pdf

The Eigenfilter method allows for approximate least-squares fitting to a desired phase response. Although not guaranteed to produce a stable filter, if conditions are set properly, it reliably generates stable filters. In addition, there are some iterative methods that get it closer to true least-squares or closer to phase equiripple. The Eigenfilter method is a powerful technique because it can be numerically stable up even up to large filter orders.

The Eigenfilter method is based upon finding an error metric that can be represented as a quadratic form in terms of the filter coefficients, such that ε=a^{T}Pa, where ε is the error, a is the vector of denominator filter coefficients, and P is a matrix. Once formulated, a can be found using Rayleigh's principle. Thus, the eigenvalues of P are proportional to the error ε and the eigenvector associated with the smallest eigenvalue is the best solution for a.

For all-pass filters, the total phase φ_{H}(ω) of an order N filter is related to the phase of the denominator φ_{A}(ω) by

φ_{H}(ω)=−Nω−2φ_{A}(ω) (2)

where ω denotes frequency in radians. One approximation to the least squares phase error of an all-pass filter is

$$ɛ \approx \frac{1}{π} \int W ( ω ) {( {a}^{T} s ( w ) )}^{2} d ω \qquad ( 3 )$$

where

s(ω)=[sin(φ_{A,des}(ω)) sin(φ_{A,des}(ω)+ω) . . . sin(φ_{A,des}(ω))+Nω)]^{T} (4)

and W(ω) is a user supplied weighting and φ_{A,des}(ω) is the desired phase of the denominator. From (1) one has

$${φ}_{A , des} ( ω ) = - \frac{1}{2} ( {φ}_{H , des} ( ω ) + N ω ) \qquad ( 5 )$$

Next, one can represent the error metric ε as a quadratic

$$ɛ = {a}^{T} Pa , \\ where P = \frac{1}{π} \int W ( ω ) s ( ω ) {s}^{T} ( ω ) d ω \qquad ( 6 )$$

The integral can be approximated with a discretized sum

$$P = \frac{1}{π} {\sum }_{i = 0}^{M} W ( \frac{i}{M} π ) s ( \frac{i}{M} π ) {s}^{T} ( \frac{i}{M} π ) \qquad ( 7 )$$

where M is the number of frequency steps to divide [0, π]. If λₘᵢₙ is the smallest eigenvalue of P, and aₘᵢₙ is the corresponding eigenvector, then the desired filter is

$$H ( z ) = \frac{{\sum }_{n = 0}^{N} {a}_{min} [ N - n ] {z}^{- n}}{{\sum }_{n = 0}^{N} {a}_{min} [ n ] {z}^{- n}} \qquad ( 8 )$$

Unfortunately, there is no guarantee that the resulting filter is stable. However, a stable filter can usually be found if the following constraint is employed

φ_{H,des}(π)=−Nπ (9)

### Eigenfilter Method Filter Design

Based on the parameterization given in FIGS. 10b and 10c, one may establish the following formulation to create a filter that achieves the desired magnitude and phase response to provide IDP correction at the listening positions.

The left and right channel desired phase responses are given by:

$$\begin{matrix}{φ}_{H , L , des} ( ω ) = \{ \begin{matrix}- N ω - \frac{π}{2} , & ( \frac{2 b - \frac{3}{2}}{n} ) π \leq ω \leq ( \frac{2 b - \frac{1}{2}}{n} ) π , & 1 \leq b \leq B \\ - N ω , & otherwise & \end{matrix} & ( 10 ) \\ {φ}_{H , R , des} ( ω ) = \{ \begin{matrix}- N ω + \frac{π}{2} , & ( \frac{2 b - \frac{3}{2}}{n} ) π \leq ω \leq ( \frac{2 b - \frac{1}{2}}{n} ) π , & 1 \leq b \leq B . \\ - N ω , & otherwise . & \end{matrix} & ( 11 )\end{matrix}$$

The least squares weights are given by:

$$W ( ω ) = \{ \begin{matrix}{w}_{pre} , & 0 \leq ω \leq ( \frac{\frac{1}{2}}{n} - \frac{Δ {f}_{beg}}{2} ) π & \\ {w}_{in} , & ( \frac{\frac{1}{2}}{n} + \frac{Δ {f}_{beg}}{2} ) π \leq ω \leq ( \frac{\frac{3}{2}}{n} - \frac{Δ {f}_{mid}}{2} ) π & \\ {w}_{in} , & ( \frac{2 b - \frac{3}{2}}{n} + \frac{Δ {f}_{mid}}{2} ) π \leq ω \leq ( \frac{2 b - \frac{1}{2}}{n} - \frac{Δ {f}_{mid}}{2} ) π , & 2 \leq b < B \\ {w}_{in} , & ( \frac{2 B - \frac{3}{2}}{n} + \frac{Δ {f}_{mid}}{2} ) π \leq ω \leq ( \frac{2 B - \frac{1}{2}}{n} - \frac{Δ {f}_{end}}{2} ) π & \\ {w}_{out} & ( \frac{2 b - \frac{1}{2}}{n} + \frac{Δ {f}_{mid}}{2} ) π \leq ω \leq ( \frac{2 b + \frac{1}{2}}{n} - \frac{Δ {f}_{mid}}{2} ) π , & 1 \leq b < B \\ {w}_{past}^{′} & ( \frac{2 B - \frac{1}{2}}{n} + \frac{Δ {f}_{end}}{2} ) π \leq ω < π ( \frac{2 b + \frac{1}{2}}{n} - \frac{Δ {f}_{mid}}{2} ) π & \\ 0 , & otherwise . & \end{matrix} \qquad ( 12 )$$

The number of bands to be phase modified, B, is given by:

$$B = ⌊ \frac{{f}_{c}}{{f}_{d}} + \frac{1}{4} ⌋ \qquad ( 13 )$$

and n is the number of sample periods corresponding to the relative time delay

$$n = \frac{\vert {d}_{L} - {d}_{R} \vert}{c} {f}_{s} \qquad ( 14 )$$

where f_{c} is the cutoff frequency above which no bands are phase adjusted; f_{d} is the frequency corresponding to a wavelength equal to the path difference; Δf_{beg}, Δf_{mid}, and Δf_{end}, are the transition width before the first band, between all bands and after the last band respectively; wₚᵣₑ, wᵢₙ, wₒᵤₜ, and wₚₒₛₜ are user defined weights for before the first band, inside the band, in-between the bands, and after the last band respectively; d_{L} and d_{R} are the distances to the two speakers from the listening location (in meters); c is the speed of sound (in m/s) and fₛ is the sampling rate (in Hz).

For the left filter, in the specified bands there is a −π/2 or −90° offset from the linear delay, and the right filter has a +π/2 or +90° offset. It can also be verified that φ_{H,L,des} and φ_{H,R,des} satisfy (9), which allows reliable finding of a stable filter. By selecting different weights, transition widths and filter order, the amount of ripple and sharpness of transition can be controlled.

### Eigenfilter Improvements

As described in the T. Q. Nguyen et al paper, it is possible to get a closer approximation to the true least-squares error by using an iterative weighting function. This leads to the following error metric

$$ɛ = {a}_{q}^{T} {Pa}_{q} , \\ where P = \frac{1}{π} \int W ( ω ) \frac{s ( ω ) {s}^{T} ( ω )}{{a}_{q - 1}^{T} c ( ω ) {c}^{T} ( ω ) {a}_{q - 1}} d ω \qquad ( 15 )$$

Where a_{q} is the filter coefficients at iteration q; s(ω) is the vector in (3) and

c(ω)=[cos(φ_{A,des}(ω)) cos(φ_{A,des}(ω)+ω) . . . cos(φ_{A,des}(ω)+Nω)]^{T} (16)

The iteration can be initialized by using the solution found with the previous method as in Tkacenko et al, and can be terminated by monitoring the change in the coefficients between iterations, ∥a_{q}−a_{q-1}∥² and stopping when it is sufficiently small, around 10⁻⁴ in practice. This method was found to work best in designing the IIR filter and significantly reduces ripple in the filter frequency response.

### IIR Magnitude and Phase Response

The Eigenfilter method with iterative error metric can reliably generate filters of any order. However, there is a noticeable jump in performance that occurs at filter orders

N=(2h−1)·n, h≧1, (17)

where n is the number sample periods corresponding to the relative time delay and h is an integer. This jump in performance corresponds to the main peaks in the ideal impulse response, which can be approximated by generating a very large FIR filter using the FIR method above. The integer h ends up dictating the maximum number of inflection points that can occur in each of the bands. In practice, it is helpful to allow for some extra samples beyond the critical point to help minimize the ripple magnitude, so in practice the following is used

N=(2h−1)·n+E, h≧1 (18)

where E is the extra samples. E=5 has found to give good performance.

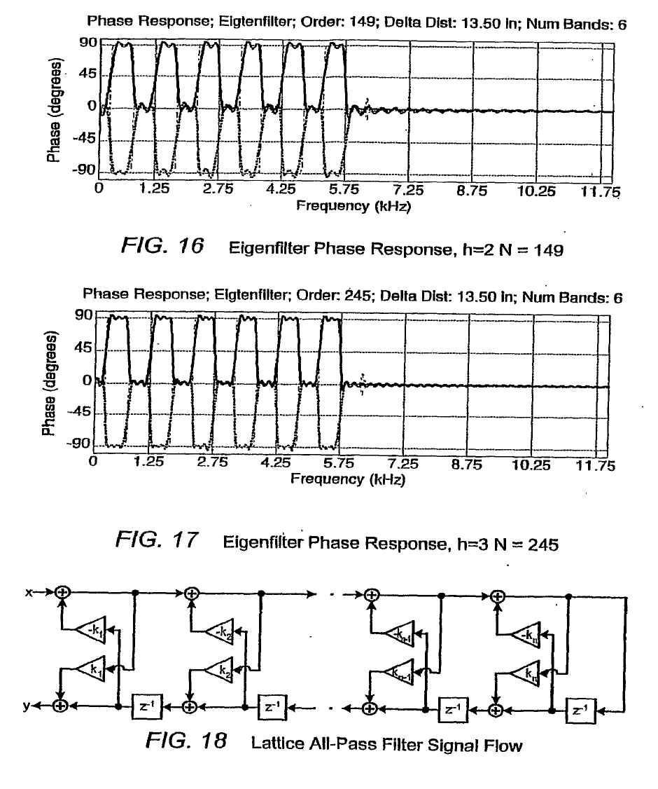

By design, magnitude response is guaranteed to be flat, and, with a proper structurally all-pass implementation, any magnitude deviation is due only to numeric precision. FIGS. 15, 16 and 17 show the phase response with different values for h.

### IIR Filter Implementation

There are numerous filter structures for implementing an all-pass IIR filter. The most basic approach is to factor the filter into a series of second-order sections (biquads). If the sections are grouped properly, this is a good way to implement general IIR filters. However, there are specialized structures that are structurally all-pass—if the coefficients are quantized, the filter is still guaranteed to be all-pass. This can lead to better numerical performance, especially in a low-precision fixed point implementations.

The all-pass filter lattice structure is preferred for the following reasons:
1. It is structurally all-pass, so that when the coefficients are quantized, the result is still an all-pass filter.
2. It has good fixed point performance. The lattice coefficients are guaranteed to be between 0 and 1, and the intermediate stages have good overflow properties.
3. It has a simple and regular structure. While it does have 2 multiplies instead of one (which can be achieved with a direct-form all-pass structures), it has a very regular multiply-accumulate structure that should port efficiently to a digital signal processor (DSP).

Thus, the implementation is shown in FIG. 18 where kⱼ-kₙ are the lattice coefficients from the filter table, x is one input sample and y is one output sample.

The lattice coefficients kₗ-kₙ can be found based on the IIR denominator coefficients aᵢ-aₙ by using the Levinson recursion. This signal flow leads to the following implementation:

a = x − k[0] * s[0];
y = s[0] + k[0] * a;
for (i = 1; i < N; ++i)
{

a = a − k[i] * s[i];
s[i−1] = s[i] + k[i] * a;

}
s[N−1] = a;

where a is an accumulator; s is the filter state array; and k is the lattice coefficients.

### IIR Filter Order Reduction

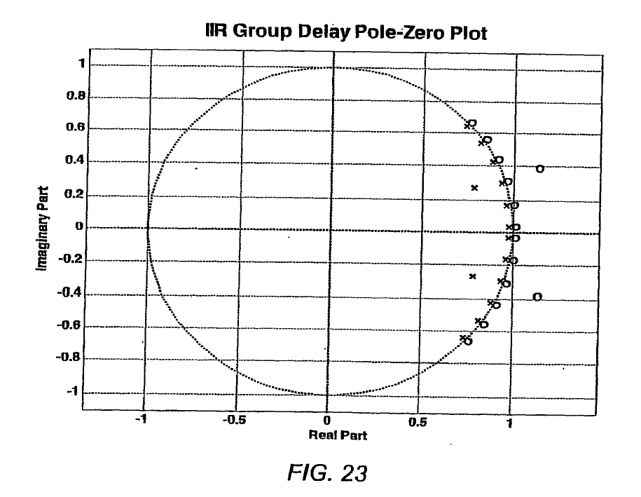

The IIR group-delay least pₜₕ order algorithm has one benefit over the eigenfilter method in that it is able to design more efficient filters. This is because it uses only the poles in the region below the cutoff frequency (<6 kHz) where the phase of bands is being modified. Above this frequency the design method ignores the phase at higher frequencies. FIG. 23 shows the pole/zero plot of a filter designed using the group delay method.

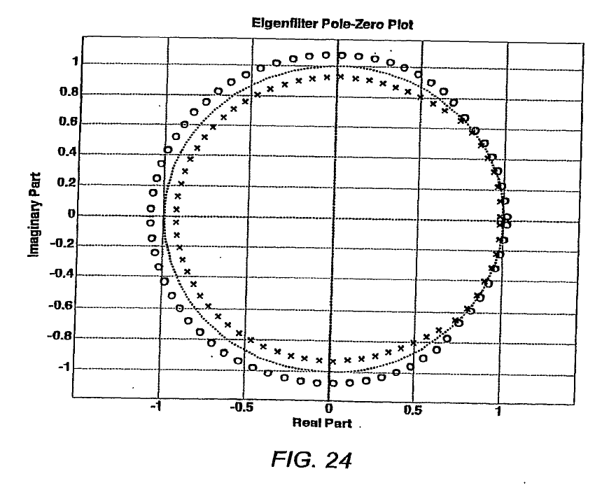

However, for the eigenfilter method to generate a filter that is stable, the constraint that φ_{H,des}(π)=−Nπ must be employed (as previously described). When assigning weights of 0 to all frequencies above the cutoff frequency, there is no way to guarantee the phase at π. Even employing a small region in the weight near π that is non-zero doesn't generate stable filters. Thus the algorithm distributes poles and zeros uniformly around the unit circle. This allows the filter to be approximately linear-phase and gives a known phase response for all frequencies. FIG. 24 shows the pole/zero plot of a filter designed using the eigenfilter method.

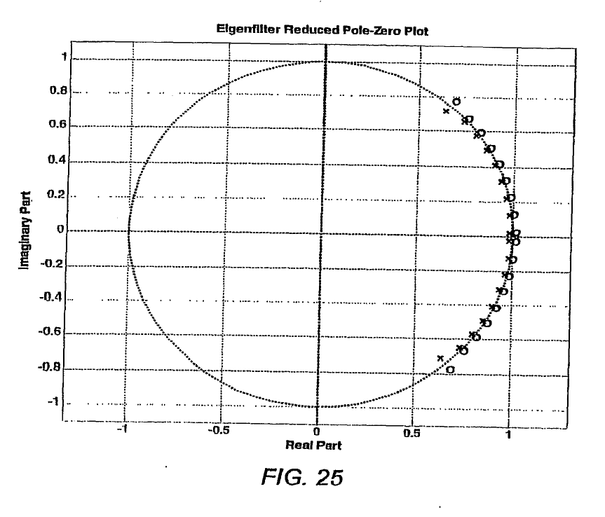

It has been found that it is possible to delete some unneeded poles and zeros after the eigenfilter algorithm has generated a stable filter. This can yield a significant filter order reduction (up to 75%) at the cost of some phase accuracy and the resulting filter is no longer approximately linear-phase at all frequencies. Because the human auditory system is phase insensitive at higher frequencies, some phase distortion due to the removal of some poles and zeros can be tolerated and will not become audible relative to the unaltered filter. FIG. 25 shows the pole/zero plot of the same filter from FIG. 24 but with approximately 73% of the poles and zeros removed. FIG. 27 shows the phase response before the reduction, and FIG. 28 shows the phase response after the reduction.

The effect of deleting a pole that is close to the unit circle has primarily a local effect on the frequencies it is near. However, there will be a small global effect on all frequencies. Therefore deleting all the high-frequencies poles can cause a noticeable phase drift from the desired frequency response as seen in FIG. 28.

One way to correct for such phase drift is to pre-warp the desired response that is used in the eigenfilter design. It is possible to find a reasonable pre-warping by finding the error between the reduced filter and the original filter, and iteratively subtracting that error from the desired phase response.

Given φ_{H,L,des}(ω), φ_{H,R,des}(ω) and W(ω), from equations (10), (11) and (12); let eigenfilter (φ_{H,des}(ω), W(ω), N) be a function that implements the eigenfilter design method described above to design a filter of length N, and let eigenfilter_reduced (φ_{H,des}(ω), W(ω), N, R) be a function that first performs the eigenfilter design and then reduces the order by factor R by keeping the lowest k poles when the poles are sorted by increasing angle where k is given by:

$$k = ⌈ \frac{N \cdot R}{2} ⌉ \cdot 2 - 1 \qquad ( 19 )$$

To calculate a reduced and corrected filter, first find the non-reduced response for the left and right filters:

a_{full,L}=eigenfilter(φ_{H,L,des}(ω),W(ω), N) (20)

a_{full,R}=eigenfilter(φ_{H,R,des}(ω),W(ω), N) (21)

and compute the relative phase between the left and right filters:

a_{fullφrel,full}(ω)=phase(a_{full,R})−phase(a_{full,L}) (22)

Next, perform a number of iterations to pre-warp the desired phase response passed to the eigenfilter design routine. First, seed the initial value of the iteration with the original desired phase response:

φ_{H,L,des,0}(ω)=φ_{H,L,des}(ω) (23)

φ_{H,R,des,0}(ω)=φ_{H,R,des}(ω) (24)

For each iterative step i, compute the reduced filters based on the updated desired response:

a_{i,L}=eigenfilter_reduced(φ_{H,L,des,i}(ω), W(w), N, R) (25)

a_{i,R}=eigenfilter_reduced(φ_{H,R,des,i}(ω), W(w), N, R) (26)

and compute the relative phase between the left and right filters:

φ_{rel,i}(ω)=phase(a_{i,R})−phase(a_{i,L}) (27)

Then find the error between the current reduced filters and the original, non-reduced filters:

Δₗ(ω)=unwrap(φ_{rel,i}(ω)−φ_{rel,full}(ω)) (28)

This error is used to update the desired response. However, because the response above the reduction cutoff is expected to be different, there should be minimal modifications to the response in this range, though it is desirable to avoid unnecessary discontinuities. One way to account for this is to have the desired response transition linearly from the last corrected frequency until Nyquist

$$C ( ω ) = \{ \begin{matrix}{Δ}_{i} ( ω ) , & 0 \leq ω \leq R \cdot π \\ \frac{- {Δ}_{i} ( R \cdot π )}{π ( 1 - R )} ω + \frac{{Δ}_{i} ( R \cdot π )}{1 - R} , & R \cdot π \leq ω \leq π\end{matrix} \qquad ( 29 )$$

Finally, create the desired response for the next iteration

$$\begin{matrix}{φ}_{H , L , des , i + 1} ( ω ) = {φ}_{H , L , des , i} ( ω ) + \frac{C ( ω )}{2} & ( 30 ) \\ {φ}_{H , R , des , i + 1} ( ω ) = {φ}_{H , R , des , i} ( ω ) - \frac{C ( ω )}{2} & ( 31 )\end{matrix}$$

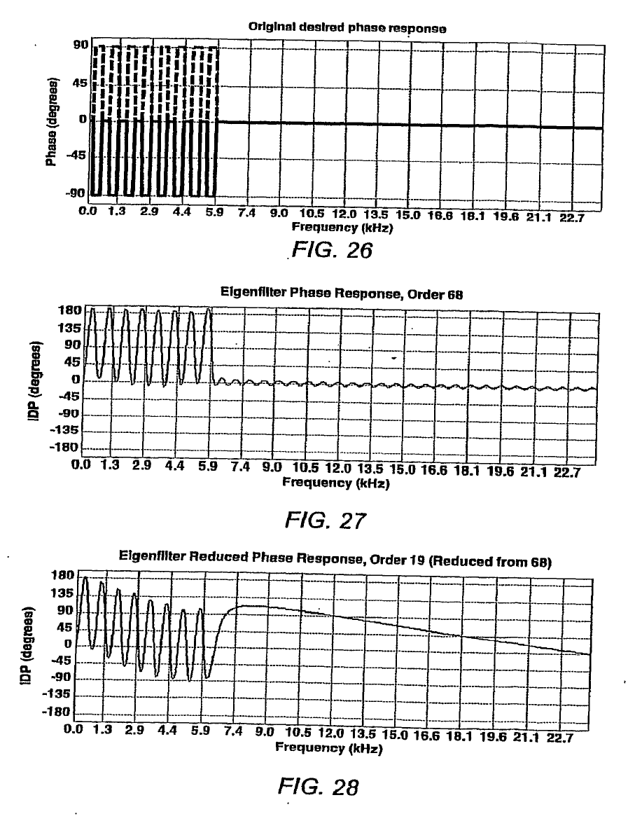

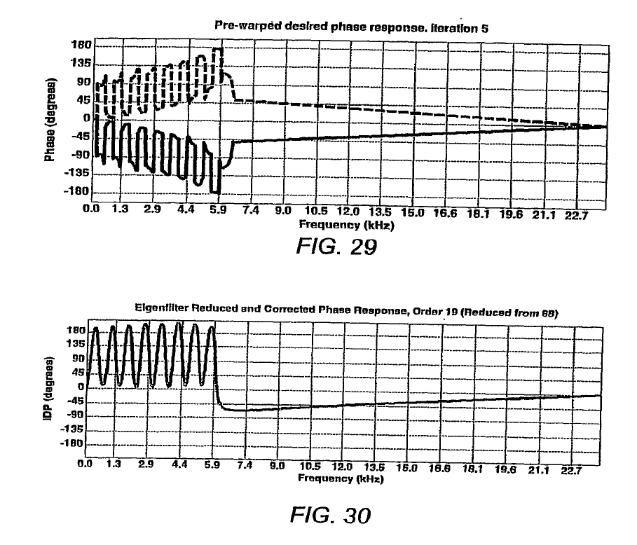

To illustrate this method, FIG. 26 shows the original phase response for the left and right filters that give the response shown in FIG. 27. After reduction the response exhibits significant phase drift, as shown in FIG. 28. To correct the drift, the desired phase response is pre-warped. FIG. 29 shows the pre-warped phase response after five iterations. This yields the corrected phase response in FIG. 30.

In practice, the response will be greatly improved within eight iterations. Sometimes after improving for several iterations, the result will diverge from the desired result and sometimes become unstable. Therefore, it is helpful to track a quality metric through the iterations, and pick the iteration that performed the best.

### In a Vehicle

FIGS. 8(a,b), 9(a,b,c) and 11(a,b) show filter and phase responses for an example where difference in distance to the two loudspeakers from each listening position is approximately 0.33 meters. Thus, the first band that is phase adjusted starts and ends at 250 Hz and 750 Hz, respectively, and the band structure repeats every 1 kHz. Although this example has been found to work for many vehicle environments, the filters could be customized for a particular vehicle by measuring its appropriate interior dimensions.

Many vehicles consist of left and right loudspeakers (or loudspeaker channels) in the front passenger area of the vehicle and left and right loudspeaker channels in the rear passenger area. Because the front passengers predominantly receive sound from the front channels and the rear passengers from the rear channels, and because the distance from the passengers to the loudspeakers may be different for front and rear passengers, it may be beneficial to apply implementations of the invention twice—once for the front loudspeakers heard by the front passengers and once for the rear loudspeakers heard by the rear passengers—with each pair of filters designed using the delta-distance associated with that row's loudspeakers and seating positions. Implementations of the invention may be repeated if there are additional rows of passengers each with additional loudspeakers. The result is that each row of passengers seated on the left and right side of the vehicle perceive improved imaging. It should be noted that the imaging is degraded for passengers seated down the center of the vehicle because the IDP is no longer zero for positions equidistant from the left and right loudspeakers—that is, passengers sitting in the center of each row of seats.

### Multiway Speakers

Many vehicles also use multi-way loudspeaker systems to reproduce the full range of audible frequencies. Low frequency loudspeakers typically are placed low in the doors and mid/high frequency loudspeakers are placed either high on the doors or on the front dashboard. In these multi-way loudspeaker configurations, the delta-distance to the listener for the low frequency loudspeakers is often different to delta-distance for the mid/high frequency loudspeakers. In this situation, and if the crossover frequency is low enough to be within the frequency range of the bands being phase adjusted, no single pair of filters can designed that works for both the low frequency and mid/high frequency loudspeakers. This problem can be ameliorated a number of ways.

First, because the human auditory system is more phase sensitive at lower frequencies, the delta distance to the low frequency loudspeakers may be used for the filter design and the upper frequency limit of the phase-adjusted bands may be reduced to approximately the loudspeaker crossover frequency.

Second, implementations of the invention may be applied multiple times to create separate pairs of filters tailored for each of the low and mid/high loudspeaker pairs. In this way, each of the low or mid/high loudspeaker pairs has filters that only adjust bands that fall in the frequency range of the loudspeakers, and each pair of filters is designed based specifically for the delta distance of the loudspeaker pair to the listener.

### Surround Sound

As described above, aspects of the invention have been found to be beneficial to the sound quality of a two-channel stereophonic presentation in which there are symmetric off-axis listening locations. Aspects of the invention also have benefits for presentations in which the stereophonic material has more than two channels (e.g., multi-channel surround). Such applications of aspects of the invention are next described.

### Four-Channel Surround

Especially in the automotive market, four-channel speaker systems are very common. Because the common surround formats include a discrete signal for a center speaker, the center signal is typically combined equally with both the left and right signals and is presented through the left and right loudspeakers. Because the left and right loudspeakers contain significant common content in that case, application of aspects of the invention to the left and right loudspeakers signals results in improved imaging for the center signal content.

Alternatively, aspects of the invention could be applied only to the center content prior to combining with the left and right channel signals. In this way, imaging is improved for common content resulting from the center channel signal, but the left and right signals are unaltered. This assumes that there is little or no common content between the left and right audio signals prior to their combining with center content.

Applying aspects of the present invention to the front left and right loudspeaker signals is important to delivering that content in the correct perceived location. In addition, using aspects of the invention for the rear speakers is also beneficial to the listening experience. For content that is intended to come from behind the listener and especially for 6.1 sources (such as Dolby Pro Logic IIx or Dolby Digital EX) aspects of the present invention applied to the rear speakers helps ensure that that rear virtual images is properly centered, and audible comb filtering effects are minimized. “Dolby”, “Dolby Digital”, “Dolby Pro Logic”, “Dolby Digital”, “Dolby Pro Logic 11x” and “Dolby Digital EX” are trademarks of Dolby Laboratories Licensing Corporation.

In a vehicle, the direct path between the front speakers and the rear passengers is often obstructed by the front seats. To compensate for this, some of the front content may be mixed into the rear speakers. By applying aspects of the invention to the rear speakers, the imaging may be improved for the rear passengers in the same way it assists the passengers.

### Five-Channel Surround or Three-Channel LCR Presentation

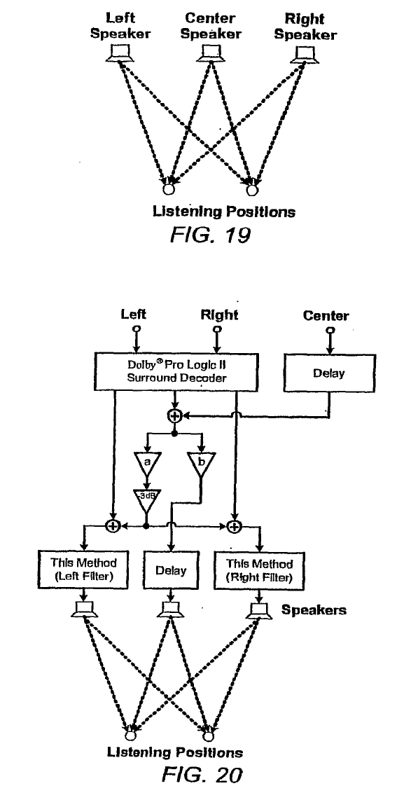

FIG. 19 shows the listening positions and loudspeaker layout for the front seats of an vehicle when left, center and right loudspeakers are present. Note that the center loudspeaker may not be on the same axis as the left and right loudspeakers but this can be adjusted by introducing delay. With this configuration, center signals appear to come from the center line of the vehicle (between the listeners), rather than in front of each listener.

One previous solution to this problem is to mix some of the center channel signal into the left and right loudspeakers and proportionally reduce the level of the center loudspeaker. Because the left listener is close to the left loudspeaker and the right listener is close to the right loudspeaker, this solution does help in pulling the center virtual image somewhat in front of each listener. However this method is limited by the fact that it also creates significant comb filtering for center content between the left and right loudspeakers.

In has been found that applying aspects of the present invention to the left and right loudspeaker signals significantly improves the center virtual imaging in this loudspeaker arrangement. This is shown in FIG. 20. Gain parameters a and b control the amount of composite center content that is mixed into the left and right loudspeakers. These parameters may be controlled such that power is conserved. That is a²+b²=1.

### Six-Channel or Seven-Channel Surround

Unlike a theater setup, when six or seven channels are used in an vehicle, they usually consist of three pairs of loudspeakers plus a possible center front channel. In this case, for the same reasons as above, it has been found to be beneficial to use implementations of aspects of the present invention on each pair of loudspeakers. A common delta distance may be used to configure the filters or for maximal effect, or each loudspeaker row pair may have unique filters calculated using unique delta distances to the nearest listeners or nearest listeners not shadowed by seats.

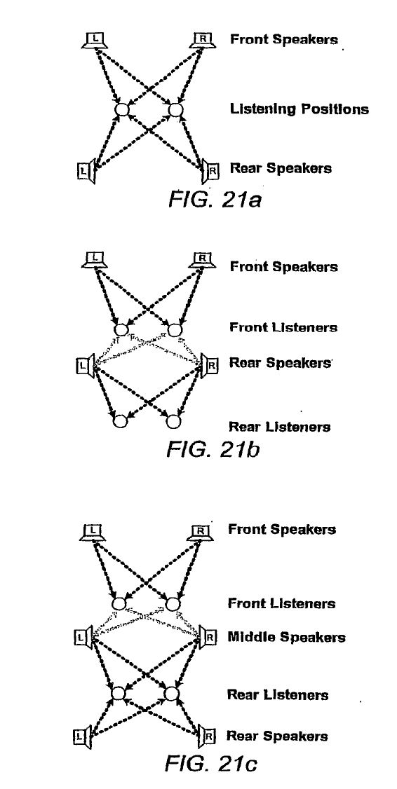

FIGS. 21a,b,c show three different examples of speaker/listener layout in an vehicle.

The example in FIG. 21a shows a four-channel loudspeaker configuration with two listening positions. Because the delta-distance at the listening position is different for the front and rear loudspeaker pairs, the signals to each row of loudspeakers may be processed using uniquely designed filter pairs.

The example in FIG. 21b shows a more traditional four-channel loudspeaker configuration with two rows of listeners. Because the front listeners primarily hear the front loudspeakers and the rear listeners primarily hear the rear loudspeakers, due to the shadowing of the front seat and the directionality of the loudspeakers, implementations of aspects of the invention may be used in each row without interference from other rows. Furthermore, if each row has a different delta-distance, filters may be designed uniquely for each row.

The example of FIG. 21c shows three rows of loudspeakers with two rows of listeners. As before, shadowing provided by the front seats causes the front listeners to primarily hear the front loudspeakers. In this example, both the middle and rear loudspeakers may have implementations of aspects of the invention applied to improve virtual images for the rear passengers. Because the middle and rear loudspeakers have different delta-distances to the rear listeners, the middle and rear loudspeakers may each have unique filter pairs.

### Implementation

The invention may be implemented in hardware or software, or a combination of both (e.g., programmable logic arrays). Unless otherwise specified, any algorithms included as part of the invention are not inherently related to any particular computer or other apparatus. In particular, various general-purpose machines may be used with programs written in accordance with the teachings herein, or it may be more convenient to construct more specialized apparatus (e.g., integrated circuits) to perform the required method steps. Thus, the invention may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion. Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the invention have been described. Nevertheless, it will be understood that various modifications may be made without departing from the spirit and scope of the invention. For example, some of the steps described herein may be order independent, and thus can be performed in an order different from that described.

1. A method for reducing phase differences varying with frequency occurring at two listening positions each symmetrically off center with respect to loudspeakers located laterally with respect to each of said listening positions and reproducing respective ones of two sound channels in a listening space, one or more loudspeakers reproducing each of the channels, the phase differences occurring as a result of acoustic characteristics of the listening space in a plurality of sequential frequency bands in which the phase differences alternate between being predominantly in-phase and predominantly out-of-phase, comprising
adjusting the relative phase between the channels in multiple alternate ones of the plurality of sequential frequency bands in which the sound channels are out-of-phase at such two symmetrically off-center listening positions.

2. A method according to claim 1 wherein the multiple alternate ones of the plurality of sequential frequency bands are centered on frequencies that are integer multiples of ½(f_{d}), where f_{d} is the frequency at which the difference in distances from loudspeakers to a listening position is one wavelength.

3. A method according to claim 1 wherein predominantly in-phase frequency bands have a relative phase difference between minus 90 and plus 90 degrees and predominantly out-of-phase frequency bands have a relative phase difference between plus 90 and plus 270 degrees.

4. A method according to claim 1 wherein said listening space is the interior of a vehicle.

5. A method according to claim 1 wherein the multiple frequency bands receiving phase adjustment include the frequency bands lower in frequency than a frequency band at which the width of the frequency band is greater than or commensurate with the width of a critical band.

6. A method according to claim 5 wherein such frequency is in the range of 4 to 6 kHz.

7. A method according to claim 1 wherein said adjusting adds a 180 degree phase shift to the relative phase between the two channels.

8. A method according to claim 7 wherein the phase on one channel is shifted by 90 degrees and the phase in the other channel is shifted by −90 degrees.

9. A method according to claim 7 wherein the adjusting is implemented by a set of filters that provides a substantially flat magnitude response and a phase response that creates a combined phase response shift between the channels with alternating bands of 0 degrees and 180 degrees.

10. A method according to claim 9 wherein said filters include finite-impulse-response (FIR) filters.

11. A method according to claim 9 wherein said filters include infinite-impulse-response (IIR) filters.

12. A method according to claim 11 wherein ones of the IIR filters are derived using an Eigenfilter method.

13. Apparatus adapted to perform the methods of claim 1.

14. A computer program, stored on a computer-readable medium, for causing a computer to perform the methods of claim 1.

15. A method according to claim 8 wherein the adjusting is implemented by a set of filters that provides a substantially flat magnitude response and a phase response that creates a combined phase response shift between the channels with alternating bands of 0 degrees and 180 degrees.

16. A method according to claim 15 wherein said filters include finite-impulse-response (FIR) filters.

17. A method according to claim 15 wherein said filters include infinite-impulse-response (IIR) filters.

18. A method according to claim 17 wherein ones of the IIR filters are derived using an Eigenfilter method.
